(19) United States
(12) Patent Application Publication
(10) Pub. No.: US 2005/0087934 A1
(43) Pub. Date: Apr. 28, 2005

(54) Eccentric modular pipe seal

(76) Inventor: James R. Richter, Lincolnshire, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/693,437

(22) Filed: Oct. 24, 2003

(51) Int. Cl. F16L 21/05

(52) U.S. Cl. 277/603

(57) ABSTRACT

A seal unit is provided for forming a seal between a pipe extending axially through a cylindrical hole, where said pipe is positioned eccentrically in said hole. The seal unit comprises a plurality of resilient compressible elastomer seal blocks, each block having a fixed height, a thickness and a width. The blocks are connectible to each other to form a ring, with a thickness of each block being arranged in a radial direction relative to the ring. A thickness of the blocks varies from block to block, with a smallest thickness block being arranged diametrically across from a largest thickness block in the ring. Intermediate blocks between the smallest thickness block and the largest thickness block have progressively increasing thicknesses leading from the smallest thickness block to the largest thickness block in each circumferential direction. The blocks can be compressed in an axial direction to cause them to expand in radial and circumferential directions, effecting a seal between the pipe and the hole.

### FIELD OF THE INVENTION

The present invention relates to pipe seals and more particularly to seals for pipes extending though wall openings.

### BACKGROUND OF THE INVENTION

A modular seal assembly known for providing positive, hydrostatic sealing of the annular space between a pipe or other conduit and a passage or casing through which the conduit extends, usually traversing a wall, is described in U.S. Pat. No. 3,528,668. Variations of that modular seal construction are disclosed in U.S. Pat. Nos. 3,649,034; 3,703,297; 5,213,341 and 5,340,123. These annular seals are each made up of a plurality of identical individual elastomer seal blocks faced with two sets of pressure plates. Bolts that interconnect the pressure plates may also join the blocks in a ring structure surrounding the conduit where it passes through a wall. The bolts are utilized to pull the pressure plates toward each other, once the annular seal structure is in place, compressing the elastomer seal blocks in a direction parallel to the conduit and expanding the seal blocks radially outwardly in the space between the conduit and the wall passage or other passage. In this way a seal structure is formed with a single set of components that may be used for many different conduit sizes. However, this type of seal arrangement works satisfactorily only when the pipe is positioned nearly precisely concentrically in a round hole in the wall. If the pipe is positioned eccentrically, due to space constrictions or due to misalignment between the pipe and the wall opening, the radial expansion of the seal may not be sufficient to provide the necessary sealing between the pipe and the opening or casing.

Arrangements for accommodating and sealing eccentrically arranged pipes in openings or casings are disclosed in a variety of U.S. patents, such as U.S. Pat. Nos. 2,295,416; 4,298,470, 4,406,484; 4,739,998; 5,286,040; 5,711,536; 5,882,014; 6,039,324; 6,386,550; and 6,394,464. Many of these arrangements utilize a fixed disk with a selected sized opening for the pipes which is mounted to move eccentrically, such as by rotation, in another disk or ring. Such arrangements cannot easily accommodate varying sized pipes, nor do they provide the compression sealing provided by the modular type of seal described in the first paragraph above.

Therefore, it would be an improvement in the art if a sealing device or arrangement were provided to allow for an eccentrically positioned pipe to be sealed within an opening or casing in a fluid tight manner, such that varying sized pipes and openings could be accommodated easily and a tight and secure seal could be effected.

### SUMMARY OF THE INVENTION

The present invention provides a device or arrangement to allow for an eccentrically positioned pipe to be sealed within an opening or casing in a fluid tight manner, such that varying sized pipes and openings can be accommodated easily and a tight and secure seal can be effected.

A plurality of link segments for a seal are provided, wherein the various segments may be of differing radial thicknesses. When linked together and placed in a surrounding relationship with the pipe, the varying thicknesses provide the correct adjustment to provide an effective seal between the opening and the eccentrically arranged pipe. A variety of sizes of link segments may be provided to choose from and the correct arrangement of segments can easily be determined from only three measurements, the outer diameter of the pipe, the inner diameter of the opening and the smallest distance between the pipe and the opening (or the greatest distance). With just these measurements, the correct number and size of the various links can be determined.

These and other features and advantages of the present invention will become apparent upon a reading of the detailed description and a review of the accompanying drawings. Specific embodiments of the present invention are described herein. The present invention is not intended to be limited to only these embodiments. Changes and modifications can be made to the described embodiments and yet fall within the scope of the present invention.

### BRIEF DESCRIPTION OF THE DRAWINGS

FIG. 1 is an end elevational view of a pipe extending through a hole, and including a seal unit embodying the principles of the present invention.

FIG. 2 is a perspective view of the seal unit of FIG. 1.

FIG. 3 is an end schematic view of the pipe and hole of FIG. 1.

FIG. 4 is a plan view of an individual seal block of the seal unit.

FIG. 5 is a side elevational view of two adjoining seal blocks, spaced slightly apart.

FIG. 6 is a plan view of another embodiment of an individual seal block of the seal unit.

### DETAILED DESCRIPTION OF THE PREFERRED EMBODIMENTS

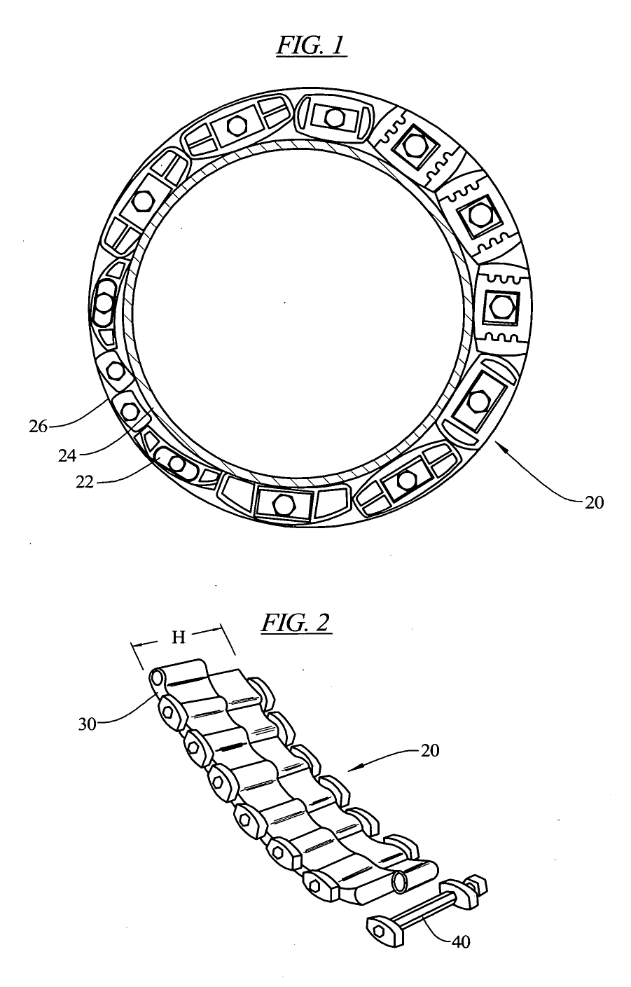

A seal unit 20 is illustrated in FIG. 1 for forming a seal in an annular space 22 between a pipe 24 extending axially through a cylindrical hole 26, where the pipe 24 is positioned eccentrically in the hole.

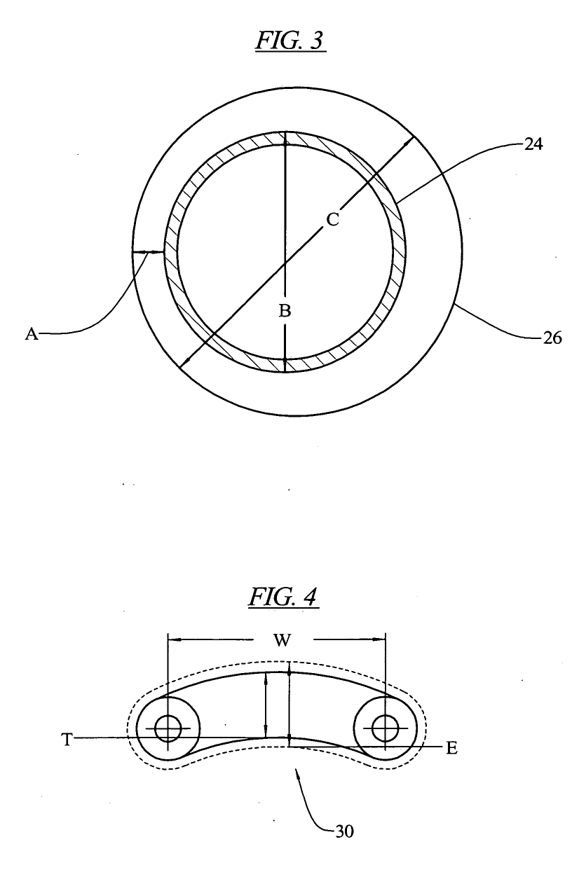

The seal unit 20 is comprised of a plurality of resilient compressible elastomer seal blocks 30 (FIGS. 4-6) arranged in a ring of blocks surrounding the pipe 24 in the hole 26. Each block has a fixed height H (which extends axially) a selected thicknesses T (see FIG. 4) and a selected width W (FIG. 4). A series of different sized blocks 30 are provided so that in assembling a particular seal unit to fit into a particular annular opening, a smallest thicknesses block is selected which has a thickness which fits in a portion of the annular space 22 between the pipe 24 and the hole 26 comprising the smallest radial dimension. A largest thickness block 30 is selected which has a thickness which fits in a portion of the annular space 22 comprising the greatest radial dimension. Intermediate blocks 30 are selected which have thicknesses between the smallest thickness and the largest thickness block. Some of the blocks 30 may be provided such that thickness at one end 30′ of the block is less than or greater than a thickness at the other end 30″ of the block and thus act as transition blocks between blocks of greater or lesser thicknesses.

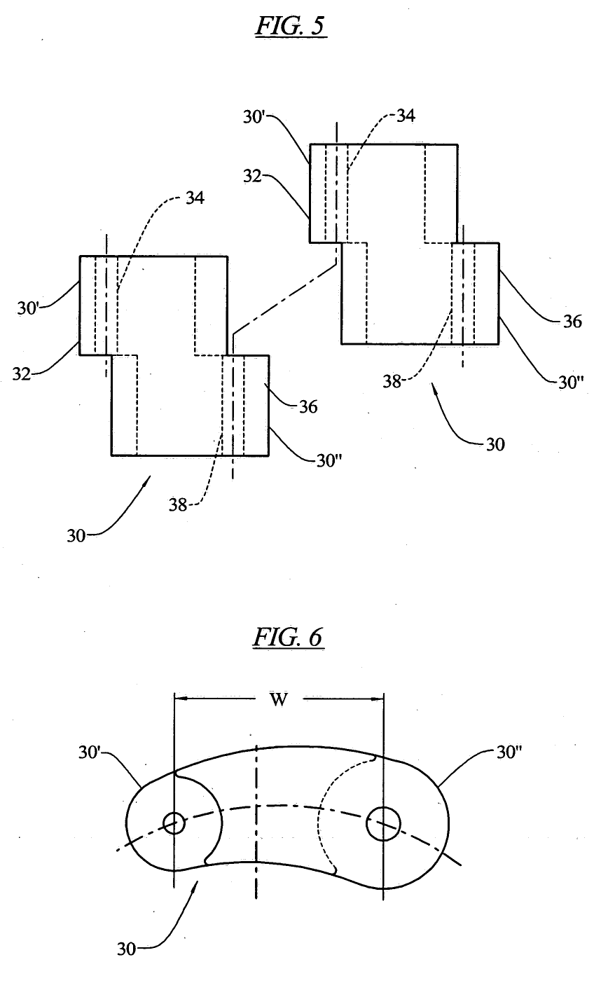

FIG. 5 shows a side elevational view of an embodiment of two sealed blocks 30 in a not yet assembled position. The seal blocks are formed in a stepped shape. An overhang portion 32 includes a passage 34 therethrough at the first end 30′ of the block 30. A lower projecting portion 36 with a passage 38 therethrough is positioned at the opposite end 30″ of the block. When two adjoining blocks 30 are positioned next to each other, the overhang 32 of one block overlies the projecting portion 36 of the other block such that the passage 34 and the passage 38 align with each other to allow a bolt 40 (FIG. 2) to extend therethrough to hold the two adjacent blocks together. In this way, a continuous belt of blocks forming the seal unit 20, as shown in FIG. 2, can be assembled and, when the first block is attached to the last block by a bolt 40, a ring is achieved which can encircle the pipe 24.

The present invention provides a method of forming a seal in the annular space 22 between the pipe 24 and the cylindrical hole 26 where the pipe is positioned eccentrically in the hole. To form such a seal, a plurality of the resilient compressible elastomer seal blocks 30 are selected to form a ring of blocks surrounding the pipe in the hole, each block having a fixed height H a selected thickness T and a selected width W. A smallest thickness block is inserted in a portion of the annular space 22 between the pipe 24 and the opening 26 comprising a smallest radial dimension. The blocks 30 are inserted such that the thickness direction of the block is arranged radially relative to the pipe 24, the height direction is arranged axially and the width direction is arranged circumferentially.

A largest thickness block 30 is inserted in the annular space 22 having the greatest radial dimension between the pipe and the opening. Intermediate blocks are similarly inserted which have thicknesses which allow the blocks to fit in the intermediate radial space between the smallest thickness block and the largest thickness block such that a complete ring surrounding the pipe is formed. The bolt 40 is extended through the height of each of the blocks 30 parallel to the axis of the pipe 24 an d then each bolt is tightened so as to compress the blocks in the axial direction, causing the blocks to expand in the radial and circumferential directions such that blocks will completely fill the annular space 22 between the pipe 24 and hole 26 to effect a seal therebetween. In an embodiment of the invention, the adjacent blocks 30 may be connected together prior to inserting any of the blocks into the annular space. In preparing the ring of blocks 30, some of the adjacent blocks may have identical widths, while the widths of some blocks may vary from block to block. Also, the thickness of some adjacent blocks may be identical, while the thickness of other blocks may vary from block to block.

Preferably a set of blocks are available of specific thicknesses in an incremental fashion. Each block has a free state thickness T and an expanded state thickness E. The expanded state thickness E is the thickness that the block will achieve when the bolts 40 are tightened to compress the block in an axial direction. For any specific portion of the circumference of the annular space 22, a block 30, which fills up a certain arcuate space, is selected such that the free state thickness T is less than the space between the pipe 24 and the cylindrical hole 26 in that arcuate area while the expanded thickness E of the block 30 is greater than that space. Thus, when the bolt 40 is tightened, the thickness T of the block 30 will expand into sealing engagement with the pipe 24 and the cylindrical hole 26. Adjacent blocks 30 will also be pressed into engagement with each other to effectively seal the space between adjacent blocks.

As illustrated in FIG. 6, some blocks 30 may be provided that have a smaller thickness at the first end 30′ and a greater thickness at the other end 30″ so as to provide a transition from one thickness size to another between blocks.

Only 3 measurements are required to determine the blocks necessary to form a suitable ring for the seal unit 20. As shown in FIG. 3, these three measurements are the smallest distance A between the pipe 24 and the hole 26; the external diameter B of the pipe 24; and the internal diameter C of the hole 26. In lieu of the smallest distance A, a greatest distance between the pipe and the hole 26 could be used. From these measurements, the length of the circumference can be determined mathematically, as can the distance between the pipe 24 and the hole 26 at any point around the circumference. Individual seal blocks 30 can be selected having the appropriate thicknesses, and based upon their various widths W, the correct number of blocks can be selected for any given combination of pipe size, hole size and degree of eccentricity. Particular pairs of adjacent blocks 30 in the seal unit may have the same or differing thicknesses T, and may have the same or differing widths W. In an embodiment, all of the blocks would have identical heights H, but this is not necessary.

The present invention has been described utilizing particular embodiments. As will be evident to those skilled in the art, changes and modifications may be made to the disclosed embodiments and yet fall within the scope of the present invention. The disclosed embodiments are provided only to illustrate aspects of the present invention and not in any way to limit the scope and coverage of the invention. The scope of the invention is therefore only to be limited by the appended claims.

1. A method of forming a seal in an annular space between a pipe extending axially through a cylindrical hole, where said pipe is positioned eccentrically in said hole, comprising the steps:
selecting a plurality of resilient compressible elastomer seal blocks to form a ring of blocks surrounding said pipe in said hole, each block having a fixed height, a selected thickness and a selected width, said selected width being less than a circumference of said pipe;
inserting a smallest thickness block in a portion of the annular space between the pipe and the opening comprising a smallest radial dimension, with the thickness direction of the block arranged radially, the height direction arranged axially, and the width direction arranged circumferentially;
inserting, in a similar orientation, a largest thickness block in a greatest radial dimension between the pipe and the opening;
inserting in similar orientations, intermediate blocks having thicknesses which will allow those blocks to fit in the intermediate radial space, between the smallest thickness block and the largest thickness block, the angular width of the selected plurality of blocks, when joined together in a ring, comprising approximately 360 degrees;
inserting a bolt through the height of each block parallel to the axis of the pipe; and
thereafter, tightening the bolts so as to compress the blocks in the axial direction, causing the blocks to expand in the radial and circumferential directions such that the blocks will completely fill the annular space between the pipe and the hole to effect a seal therebetween.

2. The method according to claim 1, including the step of connecting adjacent blocks together prior to inserting any of said blocks into said annular space.

3. The method according to claim 2, wherein a first and last block are connected together to form a ring of blocks, after said blocks have been inserted into said annular space.

4. The method according to claim 1, wherein some intermediate adjacent blocks have identical thicknesses.

5. The method according to claim 1, wherein some intermediate adjacent blocks have identical widths.

6. The method according to claim 1, wherein the width of the blocks may vary from block to block.

7. A seal unit for forming a seal in an annular space between a pipe extending axially through a cylindrical hole, where said pipe is positioned eccentrically in said hole, comprising:
a plurality of resilient compressible elastomer seal blocks arranged in a ring of blocks surrounding said pipe in said hole, each block having a fixed height, a selected thickness and a selected width, said selected width being less than a circumference of said pipe;
a smallest thickness block having a thickness, with the thickness direction of the block arranged radially, selected to fit in a portion of the annular space between the pipe and the hole comprising a smallest radial dimension, a largest thickness block having a thickness, oriented similarly, selected to fit in a portion of the annular space comprising a greatest radial dimension, and intermediate blocks having thicknesses, oriented similarly, which will allow those blocks to fit in an intermediate radial distance, between the smallest thickness block and the largest thickness block, the angular width of the selected plurality of blocks, all arranged with the width dimension arranged circumferentially, when joined together in a ring, selected to comprise approximately 360 degrees; and
a bolt extending through the height of each block parallel to the axis of the pipe;
wherein tightening of the bolts will compress the blocks in the axial direction, causing the blocks to expand in the radial and circumferential directions, such that the blocks will completely fill the annular space between the pipe and the hole to effect a seal therebetween.

8. The seal unit according to claim 7, wherein adjacent blocks are interconnected to one another.

9. The seal unit according to claim 7, wherein some intermediate adjacent blocks have identical thicknesses.

10. The seal unit according to claim 7, wherein some intermediate adjacent blocks have identical widths.

11. The seal unit according to claim 7, wherein the width of the blocks may vary from block to block.

12. A seal unit for forming a seal between a pipe extending axially through a cylindrical hole, where said pipe is positioned eccentrically in said hole, comprising:
a plurality of resilient compressible elastomer seal blocks, each block having a fixed height, a thickness and a width;
said width of each block extending in a circumferential direction relative to said pipe; with said width of each block extending less than a full circumference of said pipe;
connecting members engageable with each block to connect said blocks to each other to form a ring, with a thickness of each block being arranged in a radial direction relative to said ring, a thickness of said blocks varying from block to block, with a smallest thickness block being arranged diametrically across from a largest thickness block in said ring, with intermediate blocks between said smallest thickness block and said largest thickness block having progressively increasing thicknesses leading from said smallest thickness block to said largest thickness block in each circumferential direction.

13. A seal unit according to claim 12, wherein some adjacent blocks have identical thicknesses.

14. A seal unit according to claim 12, wherein some adjacent blocks have identical widths.

15. A seal unit according to claim 12, wherein the width of the blocks may vary from block to block.

16. The seal unit according to claim 12, wherein a bolt is provided in each block, extending through the height of each block, such that when said bolts are tightened, the blocks will compress in the height direction, but expand in the radial and circumferential directions.

17. A seal member for use in forming a seal between a pipe extending axially through a cylindrical hole, comprising:
a resilient compressible elastomer seal block, said block having a height to be oriented in an axial direction relative to said pipe, a width to be oriented in a circumferential direction relative to said pipe and a thickness to be oriented in a radial direction relative to said pipe,
said width of said block extending less than a full circumference of said pipe;
said block having an arcuate shape in said circumferential direction and having a varying thickness in the circumferential direction such that a thickness at one circumferential end of the block is less than a thickness at an opposite circumferential end of the block;
said block having an aperture therein to receive a connecting member arranged to connect two adjacent blocks together.

18. A seal member according to claim 17, wherein said block has a passage leading from said aperture extending therethrough in said axial direction.

19. A seal member according to claim 17, wherein said block has an overhanging portion at one end and a projecting portion at an opposite end, with a passage extending axially through the overhanging portion and the projecting portion, such that when a first and a second block are positioned adjacent to one another, the overhanging portion of said first block will overlie the projecting portion of said second block and the passages will align.

20. A method of forming a seal in an annular space between a pipe extending axially through a cylindrical hole, where said pipe is positioned eccentrically in said hole, comprising the steps:
providing a variety of preformed resilient compressible elastomer seal blocks, each block having a fixed height, a selected thickness and a selected width, said selected width extending in a circumferential direction and being less than a full circumference of said pipe, with some blocks having a smallest thickness, some blocks having a greatest thickness and remaining blocks having an intermediate thickness;
measuring an outer diameter of said pipe;
measuring an inner diameter of said hole;
measuring at least one of a smallest distance or a greatest distance between said pipe and said hole,
based upon said three measurements, selecting a plurality said seal blocks to form a ring of blocks surrounding said pipe in said hole, with each block having a thickness slightly less than the distance between the pipe and the hole in a particular arcuate region of the annular space to be occupied by said block;
inserting a smallest thickness block of the selected blocks in the arcuate region of the annular space between the pipe and the opening comprising a smallest radial dimension, with the thickness direction of the block arranged radially, the height direction arranged axially, and the width direction arranged circumferentially;
inserting, in a similar orientation, a largest thickness block of the selected blocks in a greatest radial dimension between the pipe and the opening;
inserting in similar orientations, intermediate blocks having thicknesses which will allow those blocks to fit in the intermediate radial space, between the smallest thickness block and the largest thickness block, the angular width of the selected plurality of blocks, when joined together in a ring, comprising approximately 360 degrees;
inserting a bolt through the height of each block parallel to the axis of the pipe; and
thereafter, tightening the bolts so as to compress the blocks in the axial direction, causing the blocks to expand in the radial and circumferential directions such that the blocks will completely fill the annular space between the pipe and the hole to effect a seal therebetween.
